(19) United States
(12) Patent Application Publication
(10) Pub. No.: US 2010/0027157 A1
(43) Pub. Date: Feb. 4, 2010

(54) MAGNETIC STORAGE APPARATUS, AND CONTROLLING METHOD THEREOF

(75) Inventor: Yoshiyuki Nagasaka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/491,972

(22) Filed: Jun. 25, 2009

(30) Foreign Application Priority Data
Jul. 30, 2008 (JP) 2008-195684

(51) Int. Cl. G11B 21/02

(52) U.S. Cl. 360/75; G9B/21.003

(57) ABSTRACT

According to an aspect of the embodiment, an MPU obtains, as a first gain value from a RDC, a gain value of a servo signal when data is read from a magnetic storage medium, and obtains, as a second gain value from the RDC, the gain value of the servo signal when data is written to the magnetic storage medium. The MPU controls supplied power for controlling flying height of the magnetic head when data is written to the magnetic storage medium based on a result of the comparing between the first gain value and the second gain value.

### CROSS-REFERENCE TO RELATED APPLICATIONS

This application is based upon and claims the benefit of priority of the prior Japanese Patent Application No. 2008-195684, filed on Jul. 30, 2008, the entire contents of which are incorporated herein by reference.

### FIELD

The embodiments discussed herein are related to a magnetic storage apparatus, and a controlling method thereof.

### BACKGROUND

In recent years, a magnetic storage apparatus (for example, a magnetic disk apparatus) has been proposed, which can change a flying height for each magnetic head, by embedding a heater or a piezo element in the magnetic head, and controlling a signal provided to the embedded heater or piezo element.

In the above magnetic storage apparatus, when an amount of power supplied to the heater embedded in the magnetic head is, for example, increased, since a slider provided with the magnetic head is expanded because of the heating by the heater, the flying height of the magnetic head is decreased. When the amount of power supplied to the heater is reduced, the expansion of the slider is reduced. Therefore, the flying height of the magnetic head is increased.

I studied a variety of techniques regarding a determining method for determining the optimum supplied power for controlling the flying height of the magnetic head in a data-reading case. For example, a technique is studied which determines that an obtained power is the supplied power to be supplied to the heater in the data-writing for all of the magnetic heads. And, the obtained power is obtained by subtracting an amount of the power corresponding to write current supplied to the specific magnetic head from the optimum supplied power supplied to the heater in the slider in the reading in order to cause the flying height in a data-writing case to be the same as a flying height in the data-reading case.

FIGS. 6A and 6B, which are studied by me and are not prior arts (are not opened and published), are diagrams for describing the above studied technique. FIG. 6A illustrates an amount of change of the flying height of the magnetic head when the optimum supplied power is supplied to the heater in the slider of the specific magnetic head in the data-reading case. A diagonal line part of FIG. 6A illustrates a part of the slider, which is expanded because of the heating by the heater (the part is the same as that of FIG. 6B). A location of a magnetic head element provided in the slider moves in a downward direction because of the expansion of the slider. The amount of change of the flying height of the magnetic head is “a” illustrated in FIG. 6 A. FIG. 6B is a diagram illustrating the amount of change of the flying height of the magnetic head because of the optimum supplied power, which is determined by the above studied technique, in the data-writing case. The above studied technique determines that the power, which is obtained by subtracting the power corresponding to the write current from the supplied power (the optimum power in the data-reading case) bringing the amount of change “a” of the flying height of the magnetic head illustrated in FIG. 6A, is the optimum supplied power in the data-writing case for all of the magnetic heads in which the power is supplied to the heater. When the determined supplied power in the writing case is supplied to the heater in the slider, as illustrated in FIG. 6B, the flying height of the magnetic head becomes the same as the flying height “a” of the magnetic head in the data-reading case, which is described above by referring to FIG. 6A. “b” in FIG. 6B is the amount of change of the flying height of the magnetic head because of the heating by the write current.

Meanwhile, such a method has been proposed (for example, refer to Patent Document 1: Japanese Laid-Open Patent Publication No. 2006-190454)) in that correspondence information between current applied to the heater and an AGC (Automatic Gain Control) gain value in the data-writing case is measured, and the correspondence information between power consumption of the heater and the flying height of the magnetic head is calculated based on a result of the measurement, thereby, the optimum current value applied to the heater in the writing case is calculated.

In the above studied technique which determines that the power obtained by subtracting the power corresponding to the write current supplied to the specific magnetic head from the optimum supplied power in the data-reading case is the supplied power to be supplied to the heater in the data-writing case for all of the magnetic heads, it is not possible to determine the optimum supplied power for each magnetic heads.

In the above technique proposed by Patent Document 1, such a complex process becomes necessary in that the correspondence information between the current applied to the heater and the AGC gain value in the data-writing case is measured, and the correspondence information between the power consumption of the heater and the flying height of the magnetic head is calculated based on a result of the measurement. Further, in the above technique proposed by Patent Document 1, the AGC gain value is detected until the magnetic head and a disk contact with each other, so that bad effect may be applied to the endurance of the magnetic head.

### SUMMARY

According to an aspect of the embodiment, a magnetic storage apparatus is a magnetic storage apparatus for controlling supplied power to control a flying height of a magnetic head. The apparatus includes a gain value obtaining unit obtaining, as a first gain value, a gain value of a servo signal when data is read from a magnetic storage medium, and obtaining, as a second gain value, a gain value of the servo signal when data is written to the magnetic storage medium; and a supplied power setting unit setting the supplied power for controlling the flying height of the magnetic head, and controlling the supplied power to control the flying height of the magnetic head when data is written to the magnetic storage medium based on a result of the comparing between the first gain value and the second gain value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a structure of a magnetic storage apparatus of an embodiment of the present invention;

FIGS. 2A and 2B are diagrams for describing the controlling for a flying height of a magnetic head;

FIG. 3 is a diagram illustrating an example of a controlling process flow for supplied power for controlling the flying height of the magnetic head of the embodiment;

FIGS. 4 and 5 are diagrams illustrating another example of the controlling process flow for the supplied power for controlling the flying height of the magnetic head of the present embodiment; and

FIGS. 6A and 6B are diagrams for describing a technique studied by me.

### DESCRIPTION OF EMBODIMENTS

The magnetic storage apparatus and the controlling method of the embodiment of the present invention for controlling the supplied power for controlling the flying height of the magnetic head control the supplied power for controlling the flying height of the magnetic head when data is written to the magnetic storage medium based on a result of the comparing between a gain value of a servo signal in the data-reading case when data is read from the magnetic storage medium, and the gain value of the servo signal when data is written to the magnetic storage medium. That is, the magnetic storage apparatus, and the controlling method for controlling the supplied power for controlling the flying height of the magnetic head determine the supplied power for controlling the flying height of the magnetic head when data is written to the magnetic storage medium by using the gain value of the servo signal, whose measured value can be easily obtained. Thus, according to the magnetic storage apparatus and the controlling method for controlling the supplied power for controlling the flying height of the magnetic head, it is possible to efficiently determine the optimum supplied power for controlling the flying height of the magnetic head when data is written to the magnetic storage medium.

Preferred embodiments of the present invention will be explained with reference to accompanying drawings.

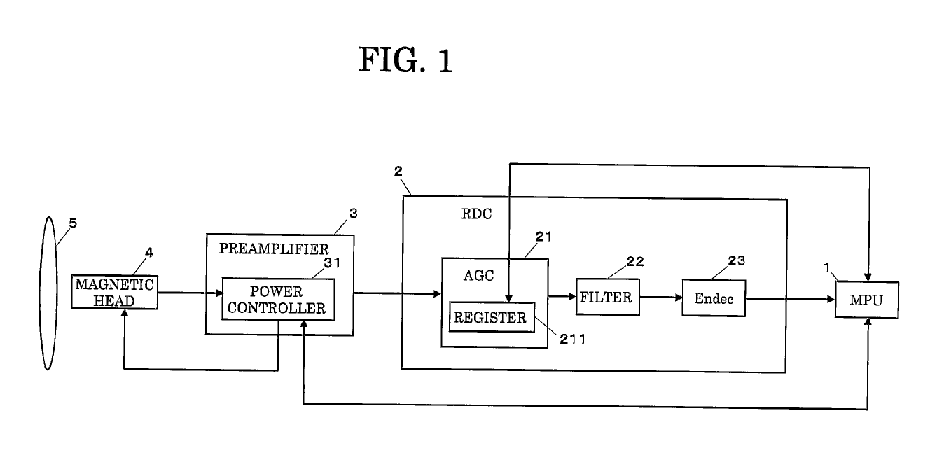

FIG. 1 is a diagram illustrating an example of a structure of a magnetic storage apparatus of an embodiment of the present invention. FIG. 1 illustrates a structure necessary for a controlling supplied power for controlling a flying height of a magnetic head of the present embodiment. The magnetic storage apparatus illustrated in FIG. 1 is, for example, a magnetic disk apparatus. The magnetic storage apparatus includes a MPU (Micro Processing Unit) 1, a RDC (Read Channel) 2, a preamplifier 3, and a magnetic head 4. The RDC 2 includes an AGC 21, a filter 22, and an Endec 23. The AGC 21 includes a register 211. The preamplifier 3 includes a power controller 31. The MPU 1 controls an well-know HDC (Hard Disk Controller) whose illustration is omitted, and controls reading of data from a magnetic storage medium (for example, magnetic disk) 5 through the magnetic head 4, and writing of data to the magnetic storage medium 5 through the magnetic head 4. The MPU 1 also obtains, as a first gain value from the AGC 21 provided in the RDC 2, a gain value of a servo signal when data is read from the magnetic storage medium 5 through the magnetic head 4. Meanwhile, the above servo signal in a data-reading case is the servo signal read by the magnetic head 4 in such a condition that the optimum supplied power, which corresponds to a predetermined data-reading case, is supplied to the magnetic head 4.

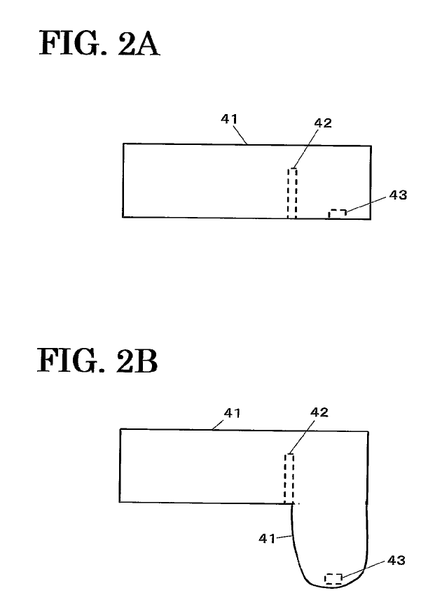

Specifically, the MPU 1 extracts and obtains the above first gain value from the register 211 in the AGC 21. The MPU 1 also obtains, as a second gain value from the AGC 21, the gain value of the servo signal when data is written to the magnetic storage medium 5 through the magnetic head 4. Specifically, the MPU 1 extracts and obtains the above second gain value from the register 211 in the AGC 21. That is, the MPU 1 is gain value obtaining unit for obtaining, as the first gain value, the gain value of the servo signal when data is read from the magnetic storage medium 5, and obtaining, as the second gain value, the gain value of the servo signal when data is written to the magnetic storage medium 5. The MPU 1 determines, based on a result of the comparing between the first gain value and the second gain value, a value of the supplied power for controlling the flying height of the magnetic head 4 when data is written to the magnetic storage medium 5. The value of the supplied power for controlling the flying height of the magnetic head 4 is a value of the supplied power supplied to a heater 42 in an after-mentioned slider illustrated in FIG. 2A. The MPU 1 also sets the determined value of the supplied power to the power controller 31 provided in the preamplifier 3. That is, the MPU 1 is supplied power setting unit for setting the supplied power for controlling the flying height of the magnetic head 4. The MPU 1 controls the supplied power for controlling the flying height of the magnetic head 4 when data is written to the magnetic storage medium 5 so that the second gain value, for example, corresponds to the first gain value.

Here, such a principle will be described in that the MPU 1 determines the supplied power for controlling the flying height of the magnetic head 4 when data is written to the magnetic storage medium 5. According to the Wallace equation expressing a relation between the flying and a wave amplitude of the magnetic head, when the wave amplitude is measured in each of two conditions of the flying magnetic head, such a fact is indicated that a ratio of the wave amplitude is proportional to a difference of the flying. Further, when the gain values of the servo signal by the AGC are equal to each other, the wave amplitudes are also equal to each other. From the above description, when the gain values of the servo signal are equal to each other, the flying heights are also equal to each other. The first gain value is the gain value of the servo signal read by the magnetic head 4 in such a condition that the optimum supplied power, which corresponds to a predetermined data-reading case, is supplied to the magnetic head 4. Thus, the MPU 1 determines the supplied power for controlling the flying height of the magnetic head 4 when data is written to the magnetic storage medium 5 so that the second gain value corresponds to the first gain value. By using the supplied power determined as described above, it is possible to cause the flying height of the magnetic head 4 in the data-writing case to correspond to the flying height of the magnetic head 4 in the data-reading case. The supplied power, which brings the flying height of the magnetic head 4 in the data-writing case corresponding to the flying height of the magnetic head 4 in the data-reading case, is the optimum supplied power for controlling the flying height of the magnetic head 4 when data is written to the magnetic storage medium 5.

Meanwhile, the MPU 1 may control the supplied power for controlling the flying height of the magnetic head 4 when data is written to the magnetic storage medium 5 so that the difference between the second gain value and the first gain value is within a range of the predetermined gain value.

The RDC 2 receives, through the preamplifier 3, the servo signal read by the magnetic head 4 when data is written to the magnetic storage medium 5, and data is read from the magnetic storage medium 5. Then, the RDC 2 determines the gain value (the gain value of the servo signal) for causing the amplitude of the received servo signal to be constant, and stores the determined gain value in the register 211. Meanwhile, as well-known, the RDC 2 filters the servo signal, whose amplitude becomes constant by using the above gain value, with the filter 22, decodes the filtered servo signal with the Endec 23, and transmits the decoded servo signal to the MPU 1. The MPU 1 executes positioning control for the magnetic head 4 as well known based on the transmitted servo signal.

As well known, the preamplifier 3 amplifies the servo signal read by the magnetic head 4 to transmit the amplified servo signal to the RDC 2. The preamplifier 3 includes the power controller 31. The power controller 31 supplies the supplied power, whose value is set by the MPU 1, to the heater 42 in the magnetic head 4, and causes the heater 42 to heat. As described later by referring to FIG. 2, the flying height of the magnetic head 4 is controlled through the expansion of the slider 41 of the magnetic head 4 by the heating of the heater 42. The magnetic head 4 executes the data writing to the magnetic storage medium 5 and the data reading from the magnetic storage medium 5.

FIGS. 2A and 2B are diagrams for describing the controlling for the flying height of the magnetic head. Reference numeral 41 in FIGS. 2A and 2B denotes a slider of the magnetic head 4 provided in the magnetic storage apparatus of the embodiment of the present invention. The slider 41 includes a magnetic head element 43, which writes and read data in and from a disk or the magnetic storage medium, and the heater 42. FIG. 2A illustrates an example of a condition of the magnetic head 4 before the power is supplied to the heater 42, and FIG. 2B illustrates an example of a condition of the magnetic head 4 when the power is supplied to the heater 42. When the power controller 31 illustrated in FIG. 1 supplies the power to the heater 42 illustrated in FIG. 2A, the heater 42 heats. Since the heater 42 heats, as illustrated in a diagonal line part of FIG. 2B, the slider 41 expands in a downward direction (a direction in which the magnetic storage medium 5 is arranged), and the flying height of the magnetic head 4 is changed because of the expanded slider 41. In the example illustrated in FIG. 2B, the flying height of the magnetic head 4 is decreased. That is, when an amount of the power supplied to the heater 42 is increased, an amount of expansion of the expanded slider 41 is increased, and the flying height of the magnetic head 4 is decreased. When an amount of the power supplied to the heater 42 is decreased, the amount of expansion of the expanded slider 41 is decreased, and the flying height of the magnetic head 4 is increased.

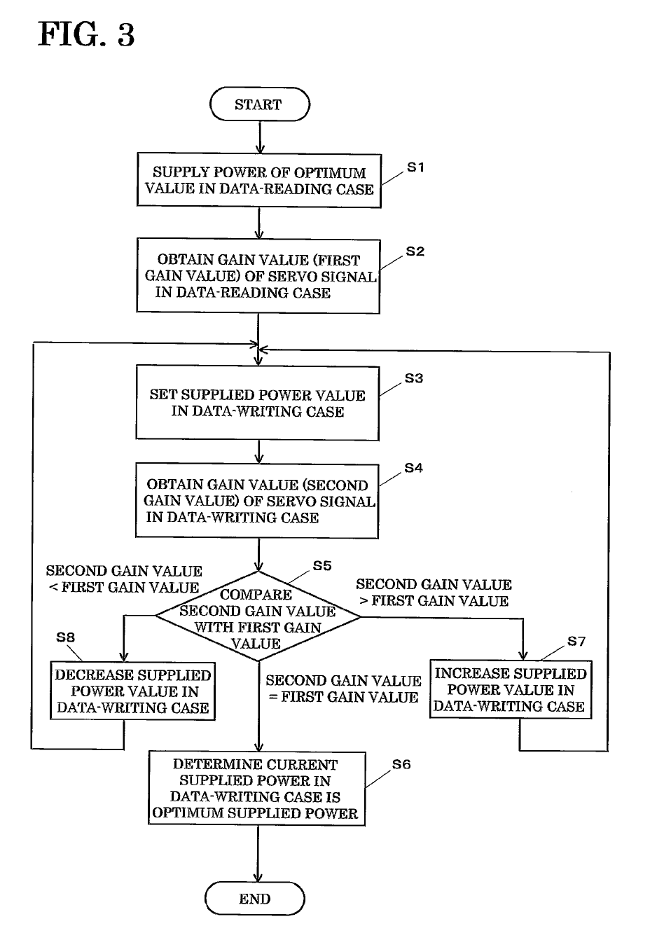

FIG. 3 is a diagram illustrating an example of a controlling process flow for the supplied power for controlling the flying height of the magnetic head of the embodiment. First, the power controller 31 of the preamplifier 3 supplies the optimum power value in the predetermined data-reading case to the heater 42 in the magnetic head 4 (step S1). Next, the MPU 1 obtains the gain value (the first gain value) of the servo signal in the data-reading case from the register 211 in the AGC 21 (step S2). The MPU 1 sets the supplied power value for the heater 42 in the data-writing case to the power controller 31 (step S3). The MPU 1 obtains the gain value (the second gain value) of the servo signal in the data-writing case from the register 211 in the AGC 21 (step S4). The MPU 1 compares the second gain value with the first gain value (step S5). Specifically, the MPU 1 determines whether the second gain value is equal to the first gain value, the second gain value is less than the first gain value, or the second gain value is more than the first gain value.

When the MPU 1 determines that the second gain value is equal to the first gain value, the MPU 1 determines that the current supplied power in the data-writing case is the optimum supplied power in the data-writing case (step S6), and the process ends. When the MPU 1 determines that the second gain value is more than the first gain value, the MPU 1 increases the supplied power value in the data-writing case (step S7), and the process returns to the step S3. Such a fact that the second gain value is more than the first gain value means that the flying height of the magnetic storage medium 5 in the data-writing case is more than the flying height of the magnetic storage medium 5 in the data-reading case. Therefore, the MPU 1 increases the supplied power value in the data-writing case to decrease the flying height of the magnetic storage medium 5.

When the MPU 1 determines that the second gain value is less than the first gain value, the MPU 1 decreases the supplied power value in the data-writing case (step S8), and the process returns to the step S3. Such a fact that the second gain value is less than the first gain value means that the flying height of the magnetic storage medium 5 in the data-writing case is less than the flying height of the magnetic storage medium 5 in the data-reading case. Therefore, the MPU 1 decreases the supplied power value in the data-writing case to increase the flying height of the magnetic storage medium 5.

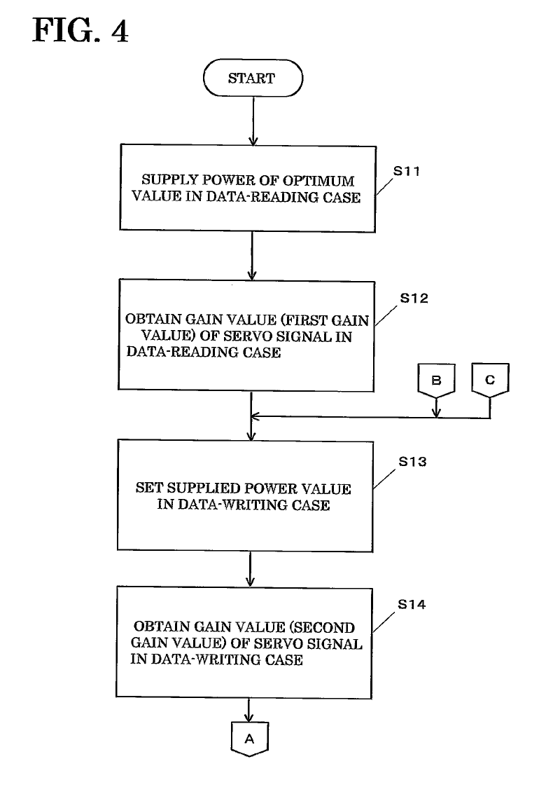

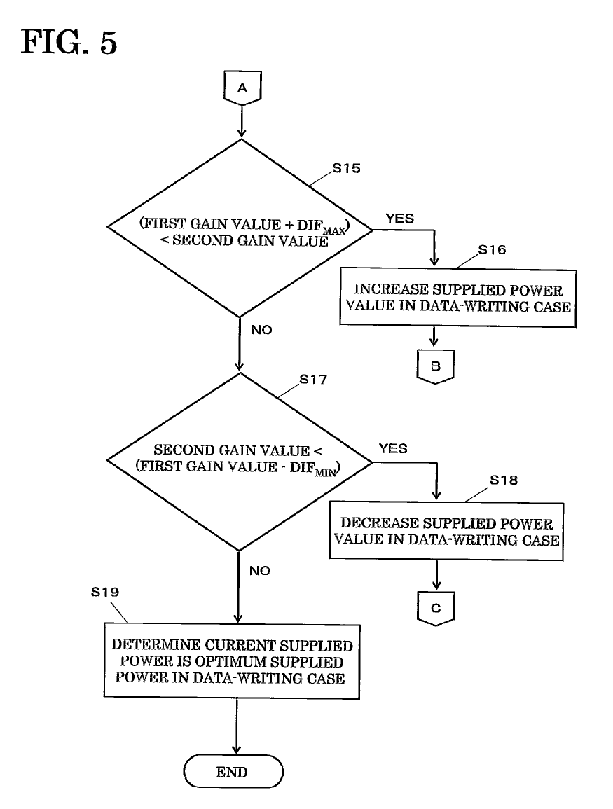

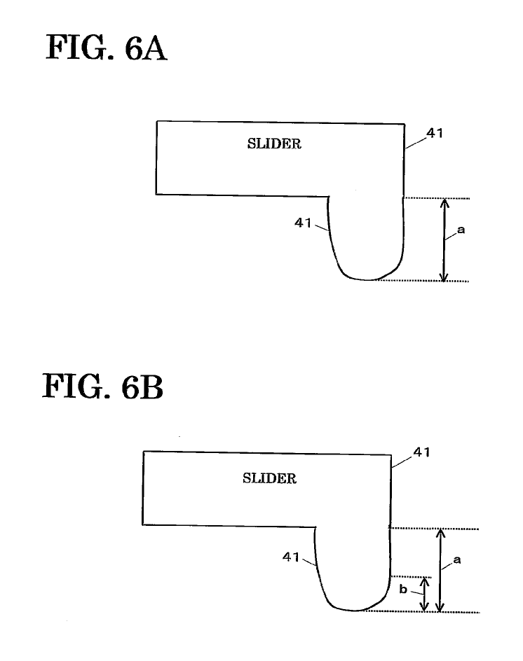

FIGS. 4 and 5 are diagrams illustrating another example of the controlling process flow for the supplied power for controlling the flying height of the magnetic head of the embodiment. As illustrated in FIG. 4, first, the power controller 31 of the preamplifier 3 supplies the optimum power value in the predetermined data-reading case to the heater 42 in the magnetic head 4 (step S11). Next, the MPU 1 obtains the gain value (the first gain value) of the servo signal in the data-reading case from the register 211 in the AGC 21 (step S12). The MPU 1 sets the supplied power value for the heater 42 in the data-writing case to the power controller 31 (step S13). The MPU 1 obtains the gain value (the second gain value) of the servo signal in the data-writing case from the register 211 in the AGC 21 (step S14), and the process proceeds to step S15 of FIG. 5.

At the step S15 of FIG. 5, the MPU 1 determines whether (the first gain value+difₘₐₓ)<the second gain value (step S15). Here, a term “difₘₐₓ” is the predetermined maximum tolerance of the difference between the first gain value and the second gain value. When the MPU 1 determines that (the first gain value+difₘₐₓ)<the second gain value, the MPU 1 increases the supplied power value in the data-writing case (step S16), and the process returns to the step S13 of FIG. 4. When the MPU 1 determines it is not that (the first gain value+difₘₐₓ)<the second gain value, the MPU 1 determines whether the second gain value<(the first gain value−difₘᵢₙ) (step S17). Here, a term “difₘᵢₙ” is the predetermined minimum tolerance of the difference between the first gain value and the second gain value. When MPU 1 determines that the second gain value<(the first gain value−difₘᵢₙ), the MPU 1 decreases the supplied power value in the data-writing case (step S18), and the process returns to the step S13 of FIG. 4. When the MPU 1 determines it is not that the second gain value<(the first gain value−difₘᵢₙ), the MPU 1 determines that the current supplied power in the data-writing case is the optimum supplied power (step S19), and the process ends.

All examples and conditional language recited herein are intended for pedagogical purpose to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A magnetic storage apparatus for controlling supplied power to control a flying height of a magnetic head, the magnetic storage apparatus comprising:
a gain value obtaining unit obtaining, as a first gain value, a gain value of a servo signal when data is read from a magnetic storage medium, and obtaining, as a second gain value, a gain value of the servo signal when data is written to the magnetic storage medium;
a supplied power setting unit setting the supplied power for controlling the flying height of the magnetic head, and controlling the supplied power to control the flying height of the magnetic head when data is written to the magnetic storage medium based on a result of the comparing between the first gain value and the second gain value.

2. The magnetic storage apparatus according to claim 1, wherein the supplied power setting unit controls the supplied power for controlling the flying height of the magnetic head when data is written to the magnetic storage medium so that the second gain value corresponds to the first gain value.

3. The magnetic storage apparatus according to claim 1, wherein the supplied power setting unit controls the supplied power for controlling the flying height of the magnetic head when data is written to the magnetic storage medium so that a difference between the second gain value and the first gain value is within a predetermined range of a gain value.

4. A method for controlling supplied power to control a flying height of a magnetic head in a magnetic storage apparatus, the method comprising;
obtaining, as a first gain value, a gain value of a servo signal when data is read from a magnetic storage medium, and obtaining, as a second gain value, the gain value of the servo signal when data is written to the magnetic storage medium; and
controlling the supplied power for controlling the flying height of the magnetic head when data is written to the magnetic storage medium based on a result of the comparing between the first gain value and the second gain value.

5. The method according to claim 4, wherein, in controlling the supplied power for controlling the flying height of the magnetic head when data is written to the magnetic storage medium, controlling the supplied power so that the second gain value corresponds to the first gain value.

6. The method according to claim 4, wherein, in controlling the supplied power for controlling the flying height of the magnetic head when data is written to the magnetic storage medium, controlling the supplied power so that a difference between the second gain value and the first gain value is within a predetermined range of the gain value.
